(19) United States
(12) Patent Application Publication
(10) Pub. No.: US 2005/0251437 A1
(43) Pub. Date: Nov. 10, 2005

(54) Adapting an interest profile on a media system

(75) Inventor: Petrus Gerardus Meuleman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/527,356

(22) PCT Filed: Aug. 18, 2003
(86) PCT No.: PCT/IB03/03653

§ 371 Date: Mar. 10, 2005

(30) Foreign Application Priority Data
Sep. 16, 2002 (EP) 02078795.8

(51) Int. Cl. G06F 17/60

(52) U.S. Cl. 705/10

(57) ABSTRACT

This invention relates to method and a media system (102) of/for adapting an interest profile (104) based on a feedback behavioral profile (301). Said method comprises the steps of: retrieving information about media content (101); retrieving implicit information (201) representing feedback information about a user's interaction with the media system, wherein said implicit information also relates to said information about media content; retrieving explicit information (202) representing feedback information about a user's rating of the media content, wherein said explicit information also relates to said information about media content; updating, by a feedback analysis (203), the feedback behavioral profile in response to at least one of implicit and explicit information; estimating a first score representing relevance of the media content based on the feedback behavioral profile and at least one of implicit and explicit information; estimating a second score based on feedback behavioral profile and the first score, wherein the second score represents reliability of the first score; and updating, by an interest profile maintenance (204), the interest profile based on said first and second scores. Said method further includes the step of: further updating the feedback behavioral profile based on said first and second scores.

This invention relates to a method of adapting an interest profile on a media system based on a feedback behavioral profile.

The present invention also relates to a computer system for performing the method.

The present invention further relates to a computer program product for performing the method.

This invention further relates to a media system for adapting an interest profile based on a feedback behavioral profile.

U.S. Pat. No. 5,717,923 discloses a method and an apparatus for dynamically customizing electronic information to individual end users. It includes a client system containing a personal profile database which stores consumer information corresponding to individual end user(s) of said client system. The client system also includes a client activity monitor which monitors actions taken by an individual end user when consuming electronic information and updates said personal profile database based on these actions.

However, the above prior-art method involves the problem that, even though it takes consumer information corresponding to the individual end user(s) into account from the past, it neither considers a relevance of a given consumer information nor does it consider the reliability of said relevance. With the lack of said reliability with respect to relevance and with only knowledge of the relevance of the consumer information, the personal profile database will, to a certain extent, contain unreliable consumer information.

It is therefore an object of the invention—apart from considering information from the past—to take both relevance information and the reliability of the relevance information into consideration before said information is subsequently used to maintain an interest profile.

The above and other problems are solved by the method mentioned in the opening paragraph, said method comprising the steps of:
retrieving information about media content;
retrieving implicit information representing feedback information about a user's interaction with the media system, wherein said implicit information also relates to said information about media content;
retrieving explicit information representing feedback information about a user's rating of the media content, wherein said explicit information also relates to said information about media content;
updating, by a feedback analysis, the feedback behavioral profile in response to at least one of implicit and explicit information;
estimating a first score representing relevance of the media content based on the feedback behavioral profile and at least one of implicit and explicit information;
estimating a second score based on feedback behavioral profile and the first score, wherein the second score represents reliability of the first score; and
updating, by an interest profile maintenance, the interest profile based on said first and second scores.

In the first step, the media system retrieves information about available media content. The information about media content may contain information about genre, type, duration, topic, category, title, beginning and/or end, etc. of available media content. Said information may further relate to an ID identifying a media provider.

In the second step, the media system may retrieve implicit information regarding a user's interaction with the media system.

In the third step, the media system may retrieve explicit information regarding a user's rating of the media content.

Said implicit and explicit information may also relate to said information about media content. Here, said information is related to information about media content.

In the fourth step, a feedback analysis may update the feedback behavioral profile with at least one of said implicit and explicit information. Here, said feedback behavioral profile may keep track of actions of the past and/or from the past, because said profile is updated with said implicit and explicit information belonging to a user. Thus, the feedback behavioral profile may comprise user-personalized information from past (inter)-action(s) with the media content on the media system in terms of implicit and/or explicit feedback.

However, said third and fourth step may be skipped. It may be the case when only implicit feedback is available and explicit feedback, i.e. the user's feedback is not given or the method may decide not to take it into account. Consequently, the update of the feedback behavioral profile may therefore also be skipped here.

In the fifth step, the media system may estimate a relevance of the media content based on the feedback behavioral profile and at least one of implicit and explicit information.

It is an advantage—with the use of the behavioral profile—to personalize the process of adaptation, resulting in a personalized relevance score.

In the sixth step, the media system may estimate a second score representing reliability of said relevance score. In the determination of the second score, correlation is used as a measure for the reliability.

In the seventh step, an interest profile maintenance may update the interest profile based on said relevance and second score. Since the second score is reliability of said relevance, the interest profile is thereby improved.

As a consequence of the improved interest profile (i.e. said interest profile when maintained), said interest profile—when subsequently used—will provide more relevant and more reliable recommendations of media content on the media system when it is subsequently used to recommend media content on said media system.

In a preferred embodiment of the method, said method further comprises the step of:
updating further the feedback behavioral profile based on said first and second scores.

Consequently, the feedback behavioral profile is adapted and adaptive in terms of quality (relevance and reliability of relevance) to the user.

In a preferred embodiment of the invention, the information about media content comprises channel ID or a program ID and at least one of metadata, topic, style, genre, category, type, duration, title, beginning and end.

In another preferred embodiment of the invention, the retrieval of implicit information comprises a supervision of the user's behavior with the media system during use of the media system.

In still another preferred embodiment of the invention, the retrieval of explicit information comprises inputs to the media system by using at least one of a keyboard, a mouse, a remote control, an interactive menu, a microphone, gesture recognition, and a joystick.

In a preferred embodiment of the invention, the media system is a set-top box, a TV, a PC, a DVD player, a radio or a VCR, wherein said media system is capable of performing an adaptation of an interest profile with use of a feedback behavioral profile, and wherein said media system is further capable of retrieving implicit and explicit feedback information.

Said problems are further solved by the media system mentioned in the opening paragraph, said media system comprising:
means for retrieving information about media content;
means for retrieving implicit information representing feedback information about a user's interaction with the media system, wherein said implicit information also relates to said information about media content;
means for estimating a first score representing relevance of the media content based on the feedback behavioral profile and at least one of implicit and explicit information;
means for estimating a second score based on feedback behavioral profile and the first score, wherein the second score represents reliability of the first score; and
means for updating the interest profile based on said first and second scores.

In a preferred embodiment of the invention, said media system further comprises:
means for retrieving explicit information representing feedback information about a user's rating of the media content, wherein said explicit information also relates to said information about media content; and
means for updating the feedback behavioral profile in response to at least one of implicit and explicit information.

In still another preferred embodiment of the invention, said media system further comprises:
means for further updating the feedback behavioral profile based on said first and second scores.

The media system gives the same advantages for the same reasons as described previously in relation to the method.

The invention will be explained more fully below in connection with preferred embodiments and with reference to the drawings, in which:

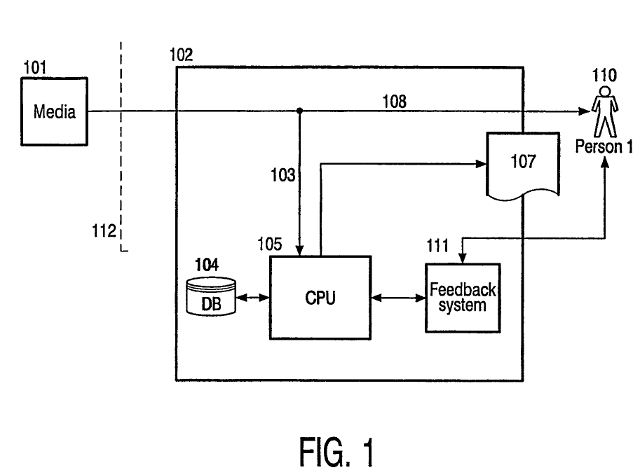

FIG. 1 shows a media system used to adapt an interest profile;

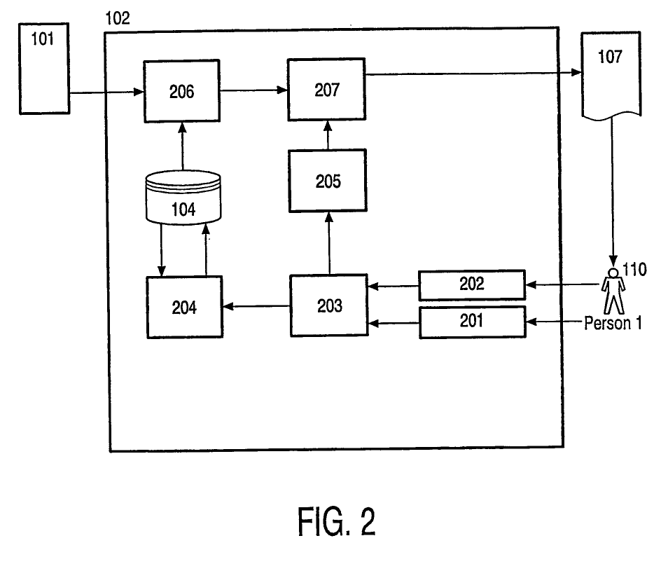

FIG. 2 shows a media system with an adaptation of an interest profile based on the interest profile;

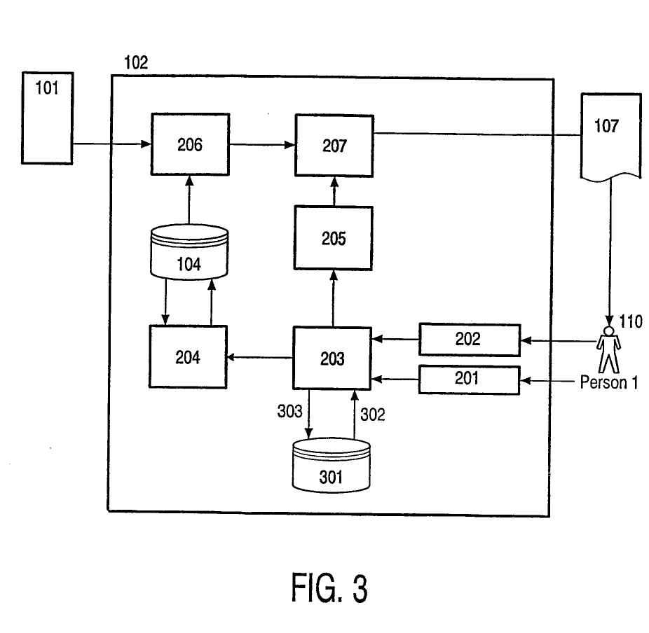

FIG. 3 shows a media system with an adaptation of an interest profile based on the interest profile and a feedback behavioral profile; and

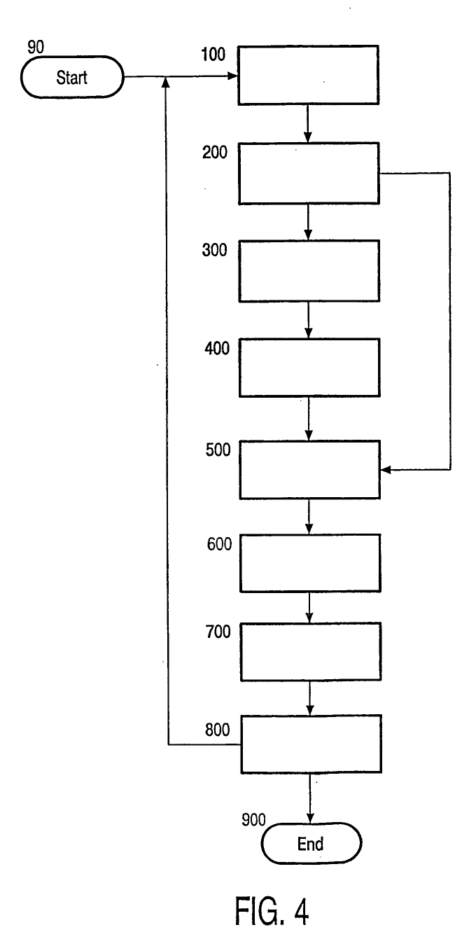

FIG. 4 shows a method of adapting an interest profile on a media system based on a feedback behavioral profile.

Throughout the drawings, the same reference numerals indicate similar or corresponding features, functions, etc.

FIG. 1 shows a media system used to adapt an interest profile. Reference numeral 101 may be a media provider providing media content available. Reference numeral 101 may comprise more than one media provider. Reference numeral 101 may also contain information about media content embedded in the reference numeral 108, the signal from 101.

Media content may be a live media content like a TV program, a video available to be seen on demand, an interactive live broadcast TV on the Internet, Internet TV, Internet sites only available when i.e. a certain event is happening, a movie, radio broadcasts or any other media which may be watched during the broadcast, or it may be a media content that may be stored on the media system—i.e. PC or a VCR—for later playback and presentation.

The information about media content is used in combination with the interest profile to adapt the interest profile in various ways. The adaptation of the interest profile will be shown in FIG. 4.

Reference numeral 102 may be the media system or part of the media system. Reference numeral 105 may be the CPU or the processing power of 102. Reference numeral 105 may update reference numeral 104, the user's interest profile for later retrieval and modification, while said interest profile may be stored in a database.

Reference numeral 105 retrieves implicit and/or explicit feedback information from reference numeral 111, a feedback system.

Reference numeral 107 may be the recommendation of media based on the interest profile and the media content available.

Reference numeral 108 is the signal from the media provider, it may be signals for downloadable videos to be seen on demand, for Internet data transmission, for TV programs, for the request of a movie, for radio broadcasts or any other media content that may be stored or presented on the media system 102. The information about media content may further be embedded in reference numeral 108.

Reference numeral 102 is the media system, it may be an Internet pc, a set-top box, a TV, a Video Cassette Recorder, a DVD player, a radio, etc. Generally, reference numeral 102 may be a system that can present the media content either live or from a recording of media content and which can recommend media based on the interest profile and the media content available.

The media system may further have a CPU or another processing power in that it may perform the retrieval of a user's rating of the media content and the estimation of a score that represents the reliability of the user's rating of that media content. The user's rating of the media content may be accomplished by input means. The input means may be a keyboard, a mouse, a remote control, an interactive menu with clicks on an onscreen menu and or a joystick where rating can be given from a user 110. The input means may further comprise input of voice via a microphone and or recognition of gesture by means of a camera.

Reference numeral 110 is one or more users of the media system 102. The user or users may watch or listen to the presented and or selected media content typically based on a recommendation using said interest profile.

Reference numeral 111 is the feedback system integrated in the media system, in the feedback system it is supervised how the users interact with the media system 102. The users may interact with the media system in the form of zapping, adjusting volume, changing the tone and the balance of tone, looking up text TV information, etc. Zapping means that the user may often be switching between different media contents. Zapping may be performed in the same way during the presentation of a radio broadcast or the presentation of a video on demand. It is further supervised by 111, the feedback system when the user switches to a radio or TV channel, to a program and to which channel or program on the radio or the TV. It may be supervised—when the media system is a PC with access to the Internet—how and to which Internet sites the user 110 surfs. It may further be supervised how the user switches between different Internet sites or homepages, correspondingly the URLs of the sites are supervised and the URLs of these sites are stored by means of 105 to the interest profile or to the database comprising said interest profile, 104 in order to have a historical reference to how and or when the user actually interacted with the Internet and/or which media content from the Internet that was actually retrieved for presentation.

Reference numeral 112 is the user connection point to the media provider 101. It may be an antenna outlet for TV or radio, a modem or ADSL connection or the like connection to the Internet, an antenna outlet from a satellite receiver, a SCART connection to a TV and or to a VCR, etc.

FIG. 2 shows a media system with an adaptation of an interest profile based on the interest profile. From FIG. 1, numeral 105 was retrieval of feedback from reference numeral 111, the feedback system. Here the retrieval of feedback is separated in an implicit feedback, reference numeral 201 and an explicit feedback, reference numeral 202.

The implicit feedback is generally retrieved in that the user of the media system is supervised during the use and/or operation of the media system. As previously discussed, implicit feedback may be derived from various ways in which the user interacts with the media system, e.g. in the form of zapping, adjusting volume, changing the tone and the balance of tone, looking up text TV information, etc. Zapping means that the user may often be switching between different media contents. Zapping may be done in the same way during the presentation of a radio broadcast or the presentation of a video on demand.

As opposed to said implicit feedback, the explicit feedback is more direct, primarily not derived information, e.g. a score representing whether the user liked (high score) or disliked (lower score) the media content presented. The explicit feedback may be the media system's retrieval of a user's rating of the media content Reference numeral 203 is the “feedback analysis”, in this analysis said implicit feedback given and/or said explicit feedback derived are considered and tied to previously mentioned information about media content.

In a preferred embodiment of the invention, a channel ID or a program ID and at least one of the following property items, such as metadata, topic, style, genre, category, type, duration, title, beginning and end, are related to feedback(s). Feedback of both types (implicit, explicit), are linked by means of said feedback analysis to either the channel ID or the program ID and/or to both and to at least one of said property items.

Reference numeral 204, an “interest profile maintenance” may use the information from the feedback analysis, reference numeral 203, in order to update the user interest profile of reference numeral 104.

The user interest profile may subsequently or currently be used to recommend media content by means of reference numeral 206, “combine and analyse”. In said recommendation of media content, reference numeral 101, the signal and the content of the signal from media provider providing media content available and said user interest profile are combined. If, as an example, the user interest profile comprises the same channel ID and one or more of the same property items as previously discussed above similar to the media content available, this channel may be recommended to the user. The recommendation may then subsequently be added to reference numeral 107, the recommendation of media.

Alternatively, reference numeral 205, an “immediate update” (of what to put on the recommendation list) not considering the information from the user interest profile may be determined.

In both cases, reference numeral 207, “sort and rank” may consider more recommendations of media content and subsequently sort them before any presentation of said recommendation of media as was shown in reference numeral 107.

FIG. 3 shows a media system with an adaptation of an interest profile based on the interest profile and a feedback behavioral profile. As opposed to the foregoing Figure, the adaptation, this Figure uses the interest profile and a feedback behavioral profile.

As an addition to FIG. 2, reference numeral 301 is a “feedback behavioral profile”, where reference numeral 303 is data or information sent to the feedback behavioral profile, whereas reference numeral 302 is data retrieved from said behavioral profile.

As previously discussed, reference numeral 203 is the feedback analysis for implicit and/or explicit feedback tied to information about media content.

When the channel ID or the program ID and at least one property item such as metadata, topic, style, genre, category, type, duration, title, beginning and end are related to feedback(s) by means of the “feedback analysis” and when further said information is stored to said feedback behavioral profile, this profile may be used in the future to retrieve information stored in the past. Said feedback behavioral profile may be used to keep track of actions (implicit, explicit), i.e. user-personalized or related info from the past.

In other words, in this Figure—as opposed to the foregoing Figure—the feedback analysis may also take the data from said feedback behavioral profile into account, wherein, generally, information about the user from the past may be used in a subsequent update (by means of the interest profile maintenance) of the user's interest profile as shown in reference numeral 104.

FIG. 4 shows a method of adapting an interest profile on a media system based on a feedback behavioral profile.

In step 90, the method is started. Variables, flags, buffers, etc., keeping track of first and second scores, the interest profile, the feedback behavioral profile, the reliability, relevance, etc, on said media system are set to default values. When the method is started a second time, only corrupted variables, flags, buffers, types, etc, are reset to default values.

In step 100, information about available media content may be retrieved. Apart from the media content presentable on the media system, available media content may further have information about style, type, duration, topic, category etc., which may be derived from the meta-data in the signal from the media provider. The media provider generally provides media content to the media system. The meta-data contains textual and codified information about media content. In the television world, the standardised DVB-Service Information contains information on electronic programme guides as information about media content. The information about media content may also be derived from text TV information sent during broadcast of TV programs. The information about media content may contain information about genre, type, duration, topic, category, title, beginning and/or end, etc. of available media content. Said information may further relate to an ID for a program broadcast about to happen or currently taking place, i.e. said information about media content may further comprise channel ID or a program ID, identifying the media provider. Corresponding information, identifying another media provider—compared to said ID—may be comprised when the media signal is received from the Internet. With said information, the media system at this step may have information ready for a subsequent match with an interest profile, when media content of a matched content may have to be suggested or recommended.

In step 200, implicit information may be retrieved, which implicit information may represent feedback information about a user's interaction with the media system. Said implicit information may also relate to said information about media content. Said implicit information may be derived during supervision of the user's behavior with the media system during the use of the media system. The implicit feedback is generally retrieved in that the user of the media system is supervised during use and/or operation of the media system. Implicit information maybe derived from various ways of interaction with the media system: zapping, adjusting volume, changing the tone and the balance of tone, looking up text TV information, etc.

In step 300, explicit information may be retrieved. The explicit information ay represent feedback information about a user's rating of the media content. Said explicit information may also relate to said information about media content.

Generally, for steps 200 and 300, said implicit and explicit information may be related to an ID identifying the media provider, e.g. a channel ID, a program ID or an U) from an Internet provider of media content. Furthermore, said implicit and explicit information may also be retrieved with property information (belonging to said ID) such as topic, style, genre, category, type, duration, title, time for beginning or time for end.

In step 400, a feedback analysis may update the feedback behavioral profile in response to at least one of implicit and explicit information. Generally, said feedback behavioral profile keeps track of actions of the past and/or from the past, because said profile is updated with said implicit and explicit information belonging to a user. Thus, the feedback behavioral profile may comprise user-personalized information from past (inter)-action(s) with the media content on the media system in terms of derived (implicit) and/or direct feedback (explicit) related to both said ID (identifying the media provider) and said property information.

In a simple update of said feedback behavioral profile by means of the feedback analysis, it is updated solely with the explicit information, i.e. a score given for a certain media content where the score is comprised in said explicit information relating to said media content.

However, if only implicit information relating to said media content is available, the update by the feedback analysis of said feedback behavioral profile cannot be estimated by way of the explicit information, and the media system may have to interpret a behavior of the user in order to update said feedback behavioral profile properly. In this case—because the update is derived from the interpreted behavior of the user—the update may not be 100 percent reliable.

With respect to the above possibility, said steps 300 and 400 may be skipped. It may be the case that only implicit feedback is available and explicit feedback, i.e. the user's feedback, is not given or does not need to be taken into account. Consequently, step 400, the update of the feedback behavioral profile may also be skipped.

This is indicated in the Figure by an alternative arrow from step 200 to step 500, skipping step 300 and 400.

It may further be the case that explicit information and implicit information are both available, and in such a case the explicit information may be used to support the less trustworthy, less reliable implicit information. The implicit information and the explicit information may here be considered in common by the feedback analysis in order to update the feedback behavioral profile.

In step 500, a first score may be estimated. The first score may represent relevance of the media content based on the feedback behavioral profile and at least one of implicit and explicit information.

As discussed in step 400, three cases may be possible: first, the explicit information is used, secondly, the implicit information is used, and finally, explicit and implicit information are used. However, in all of these three cases—as opposed to the foregoing step—the information from the feedback behavioral profile is further considered when said first score is estimated.

First, in a simple estimate of the first score, it may be equated to the explicit information, i.e. the score for a certain media content where the score is comprised in said explicit information relating to said media content. In such a case—because the score is given directly by the user—it may be nearly 100 percent reliable. Especially, if explicit information from the feedback behavioral profile—for a corresponding media content (e.g. same type, genre, etc.)—has a score on the same or similar level, this would be in support of a more reliable estimate on the first score.

Secondly, if, however, only the implicit information relating to said media content is available, i.e. the first score cannot be estimated by way of the explicit information, the media system may have to interpret a behaviour of the user together with information from the feedback behavioral profile in order to estimate the first score. In this case—because the score is estimated—it will not be 100 percent reliable, but opposed to the foregoing step, it will be more reliable because information from the past, i.e. the feedback behavioral profile is also considered in the estimate.

Finally, it may further be the case that explicit information and implicit information are both available on the media content discussed. In such a case, the explicit information may be used to support the less trustworthy, less reliable implicit information. The implicit information and the explicit information may here be considered in combination with information from the past, i.e. with information from the feedback behavioral profile in order to determine the first score.

In all cases, in this step, the first score determines the relevance (of the media content discussed) for the user.

It is an advantage—with the use of the behavioral profile—to personalize the interpretation process, resulting in a personalized relevance score, i.e. said first score.

In step 600, a second score may be estimated based on feedback behavioral profile and the first score, wherein the second score represents reliability of the first score.

As discussed in the foregoing step, in some cases, the first score was unreliable, i.e. not thrustworthy for a subsequent use when used to recommend media content.

In all cases—as just discussed in the foregoing step—feedback information (explicit or implicit) was converted into a first score, i.e. the relevance of the media content.

This was relatively simple for the explicit feedback where explicit information could be directly converted into the relevance score with a nearby 100 percent reliability.

However, for the implicit score, the media system may have to interpret the behaviors of the user in the form of an implicit feedback given. This is more complex—as compared to the explicit information—because the explicit feedback may not be directly converted into the relevance score, and furthermore said relevance score may have a low reliability due to uncertainty as how to interpret the user's behavior during operation of the media system.

In order to improve the reliability, i.e. to obtain a higher reliability in this step—as compared to step 400—the information comprised in the feedback behavioral profile is further taken into account in the determination of said second score.

In said determination of said score, a so-called correlation (coefficient) is used. The correlation is used to determine to which degree two variables are related. The correlation may have a value between minus one and plus one. The sign (plus or minus) defines the extent of relationship. A positive correlation means that when a value of one variable increases, the value of the other variable increases, and when it decreases, the other one decreases. A negative correlation indicates that when one variable increases, the other one decreases, and vice versa.

Correspondingly, in the behavioral profile, an explicit relevance score, i.e. the score of relevance from explicit feedback, which is the second score in this case—may be correlated with implicit behavior pattern, i.e. the information from implicit feedback.

Furthermore, in the behavioral profile, an implicit relevance score, i.e. the score of relevance from implicit feedback—which instead represents the second score in this case—may be generated from earlier observed explicit relevance scores (retrieved from the behavioral profile) in combination with this behavioral pattern.

Generally, said correlation is a measure of the reliability.

In summary, the following relations between actions from the user in terms of implicit and explicit feedback and the subsequent update of the interest and the behavioral profile can be shown in Table 1 below:

TABLE 1

| | | To interest profile | Actions in the behavioral |
|---|---|---|---|
| | User action | maintenance | profile |
| 1 | Explicit | Explicit relevance | |
| | feedback | score with 100% | |
| | | reliability | |
| 2 | Explicit + | Explicit relevance | In behavioral profile: correlate |
| | implicit | score with 100% | explicit relevance score with |
| | feedback | reliability | implicit behavior pattern |
| 3 | Implicit | Implicit relevance | In behavioral profile: |
| | feedback | score with uncertain | generate implicit relevance |
| | | reliability | score from earlier observed |
| | | | explicit relevance scores in |
| | | | combination with this |
| | | | behavioral pattern. The |
| | | | correlation may be a measure |
| | | | of the reliability. |
| | | | Additionally: ask for explicit |
| | | | feedback from the user, if given |
| | | | proceed as in 1. |

The actions stated above in the behavioral profile will be discussed in the next step.

As an example, implicit feedback given by the user may be interpreted in two very different ways: (the media content) is liked or disliked. The correct interpretation depends on the particular user. It is therefore possible to specify user's interest or dislike of the media content related with that implicit feedback information by referencing to the user's treatment of that or similar media content previously given in the explicit and/or implicit feedback previously stored to the feedback behavioral profile. An example of implicit feedback that may be interpreted in two very different ways may be zapping behavior which may be interpreted at either:
1) The user is expecting and waiting for other more popular media content, e.g. other TV program(s), or
2) The user is watching several popular media content (TV program(s)) at the same time.

Of course 1) implies a dislike, whereas 2) implies that (more) media content is/are liked, and as can be seen, the correct interpretation depends very much on the particular user.

In other words, by using of data from the past, said feedback behavioral profile, inter-personal ambiguity in interpretation of behavioral patterns (implicit and explicit feedback) is removed.

Thus, it is an advantage—with the use of the behavioral profile—to personalize the interpretation process resulting in a personalized reliability, i.e. said second score.

In step 700, an “interest profile maintenance” may update the interest profile. The update may be based on said first and second scores. In order to improve the interest profile in terms of both relevant and reliable data, said interest profile may be updated with said scores.

In this case, it is an advantage that the interest profile is now enhanced (improved, (i.e. adaptive) in terms of quality (first and second scores), quantity of data from the past, i.e. feedback behavioral profile; in this case, the user interest profile is maintained and adapted to the user according to the invention.

As a consequence of the improved interest profile—when it is subsequently used to recommend media content on said media system—it will provide more relevant and more reliable recommendations of media content on the media system.

In step 800, the feedback behavioral profile may further be updated on the basis of said first and second scores. As opposed to the step of updating the feedback behavioral profile with one of implicit and explicit information, this update may here be based on said first and second scores. In order to improve the historical data stored from past interactions, said feedback behavioral profile may further be updated in terms of both relevant (said first score) and reliable data (said second score).

In this case, it is an advantage that the feedback behavioral profile is now adapted and adaptive in terms of quality (first and second scores); in this case, said feedback behavioral profile is maintained and adapted to the user.

The discussion about having said step 300 and 400 possibly skipped, i.e. as optional steps, leads to indentifying two different processes (within the method):

Process 1, with training of the behavioral profile, and—conversely—a process 2 with use of the behavioral profile:

In other words, process 1—training of the behavioral profile—may then comprise the steps of:
retrieving implicit information event AND retrieving explicit information event, i.e. with user rating(s);
calculating a correlation between these two types of information events, based on this observation and information about previous observations stored in the behavioral profile, and then stored to the behavioral profile; and
updating the interest profile with user rating from explicit feedback.
whereby a high reliability is achieved and secured for subsequent use of the interest profile.

Process 2—using the behavioral profile—may then comprise the steps of:
retrieving implicit information event, i.e. without explicit information event;
searching the behavioral profile for high correlations between this implicit information and explicit information (from previous—trained observations—in process 1);
estimating the user score and the reliability on the basis of previous explicit information events, with the highest correlation(s) with this implicit information event; and
updating the interest profile with this estimated user score and reliability.

Both processes can and will be mixed during normal use. Which of the two processes that is used may be determined by the user feedback. If there is both explicit and implicit feedback, process 1 may take place; if there is only an implicit feedback, process 2 is run.

Usually, the method will start all over again as long as the media system is powered. Otherwise, the method may terminate in step 900; however, when the media system is powered again, etc., the method may proceed from step 100.

Said media system may be a set-top box, a TV, a PC, a DVD player, a radio or a VCR capable of performing an adaptation of an interest profile, using a feedback behavioral profile, retrieved implicit and explicit feedback information.

A computer-readable medium may be a magnetic tape, an optical disc, a digital video disk (DVD), a compact disc (CD recordable or CD writeable), a mini-disc, a hard disk, a floppy disk, a smart card, a PCMCIA card, etc.

1. A method of adapting an interest profile on a media system based on a feedback behavioral profile, said method comprising the steps of:
retrieving information about media content;
retrieving (200) implicit information (201) representing feedback information about a user's interaction with the media system, wherein said implicit information also relates to said information about media content;
estimating (500) a first score representing relevance of the media content based on the feedback behavioral profile and at least one of implicit and explicit information;
estimating (600) a second score based on feedback behavioral profile and the first score, wherein the second score represents reliability of the first score; and
updating (700), by an interest profile maintenance (204), the interest profile based on said first and second scores.

2. A method as claimed in claim 1, characterized in that the method further comprises the steps of:
retrieving (300) explicit information (202) representing feedback information about a user's rating of the media content, wherein said explicit information also relates to said information about media content; and
updating (400), by a feedback analysis (203), the feedback behavioral profile in response to at least one of implicit and explicit information.

3. A method according to claim 1, characterized in that the method further comprises the step of:
updating (800) further the feedback behavioral profile based on said first and second scores.

4. A method according to claim 1, characterized in that the information about media content comprises channel ID or a program ID and at least one of metadata, topic, style, genre, category, type, duration, title, beginning and end.

5. A method according to claim 1, characterized in that the retrieval of implicit information comprises a supervision of the user's behavior with the media system during use of the media system.

6. A method according to claim 1, characterized in that the retrieval of explicit information comprises inputs to the media system by using at least one of a keyboard, a mouse, a remote control, an interactive menu, a microphone, gesture recognition, and a joystick.

7. A method according to claim 1, characterized in that the media system is a set-top box, a TV, a PC, a DVD player, a radio or a VCR.

8. A computer system for performing the method according to claim 1.

9. A computer program product comprising program code means stored on a computer-readable medium for performing the method of claim 1 when the computer program is run on a computer.

10. A media system (102) for adapting an interest profile based on a feedback behavioral profile, said media system comprising:
means for (105) retrieving information about media content;
means for (105) retrieving implicit information representing feedback information about a user's interaction with the media system, wherein said implicit information also relates to said information about media content;
means for (105) estimating a first score representing relevance of the media content based on the feedback behavioral profile and at least one of implicit and explicit information;
means for (105) estimating a second score based on feedback behavioral profile and the first score, wherein the second score represents reliability of the first score; and
means for (204) updating the interest profile based on said first and second scores.

11. A media system according to claim 10, said media system further comprising:
means for (105) retrieving explicit information representing feedback information about a user's rating of the media content, wherein said explicit information also relates to said information about media content; and
means for updating (203) the feedback behavioral profile in response to at least one of implicit and explicit information.

12. A media system according to claim 10, said media system further comprising:
means for (105) further updating the feedback behavioral profile based on said first and second scores.
